(19) United States
(12) Patent Application Publication
(10) Pub. No.: US 2025/0272796 A1
(43) Pub. Date: Aug. 28, 2025

(54) DEVICE AND METHOD OF SYNTHETIC IMAGE GENERATION

(71) Applicant: Robert Bosch GmbH, Stuttgart (DE)

(72) Inventors: Anna Khoreva, Berlin (DE); Dan Zhang, Leonberg (DE); Jiayi Wang, Minden (DE); Yumeng Li, Barcelona (ES)

(21) Appl. No.: 19/061,230

(22) Filed: Feb. 24, 2025

(30) Foreign Application Priority Data
Feb. 26, 2024 (DE) 10 2024 201 757.4

(51) Int. Cl. G06T 5/60; G06T 5/70; G06T 11/00

(52) U.S. Cl. CPC G06T 5/60; G06T 5/70; G06T 11/00; G06T 2207/20081; G06T 2207/20084

(57) ABSTRACT

A computer-implemented method for generating synthetic images using a conditional diffusion model. The method involves providing a neural conditioning, which is determined by a foundation model, as input to a ControlNet. The neural conditioning and a latent input representation are then propagated through the ControlNet, and the outputs of the ControlNet are used as additional injections for the diffusion model. The latent input representation is further propagated through the diffusion model, with the additional injections from the ControlNet being injected into corresponding layers of the diffusion model during propagation.

### CROSS REFERENCE

The present application claims the benefit under 35 U.S.C. § 119 of German Patent Application No. DE 10 2024 201 757.4 filed on Feb. 26, 2024, which is expressly incorporated herein by reference in its entity.

### FIELD

The present invention concerns a method for generating synthetic images using a conditional diffusion model, and a method for operating an actuator, a computer program and a machine-readable storage medium, a classifier, a control system, and a training system thereof.

### BACKGROUND INFORMATION

Recent large-scale text-to-image generative models, e.g., Stable Diffusion, have demonstrated an impressive ability to generate diverse and creative images given a text prompt. However, it's hard to have fine-grained control over the generation process, e.g., control the layout of the image and location of the objects. Recent work ControlNet is built on top of Stable Diffusion (SD) and introduce an additional branch, i.e., a trainable copy of the UNet encoder in SD, to accommodate the additional condition, e.g., segmentation label map, depth. However, the ground-truth label map or depth annotation can be costly. Besides, the raw conditional information may lack of high-level meaningful semantic information, and the model can ignore the conditional information and thus the synthesized image is not aligned with the input condition.

### SUMMARY

According to the present invention, it is provided to use per-pixel neural representation of an image as the conditioning information, i.e., features extracted from a pretrained foundation model (e.g., DINO, Stable Diffusion). In this way, no expensive annotation is required (thus reduction of annotation costs and availability of large volume of unlabeled data for training), and the extracted features contain rich semantic information as well, which leads to better synthesis quality and alignment with the condition.

The present invention does not require manual annotations to obtain the conditioning information, which significantly reduces the cost of creating datasets for fine-tuning and allows to use large volumes of unlabeled data for training. Despite the reduced costs, the invention can still specify the semantic layout when using neural representations that encode this information. Furthermore, the neural representation captures additional scene information that cannot be described using semantic labels alone (e.g., object orientation). This enables additional application for downstream tasks of data creation for the purpose of training neural networks. Since object orientation is preserved, the synthesized data can reuse bounding box annotation from the original image for training a pose estimator, in addition to training a segmenter.

In a first aspect, in an example embodiment of the present invention, a novel format of conditional information for fine-tuning diffusion models is proposed, where the condition can be effectively utilized by the diffusion models leading to improved synthesis quality and alignment. Prior work ControlNet, has a trainable copy of the UNet encoder and feed conditions such as semantic label map as input to the network. After being added to the noisy latent and being processed by the stacks of layers, the features are inserted to the original denoising UNet of Stable Diffusion, which is frozen during the fine-tuning. However, controlling the image generation using label maps is costly for fine-tuning, and lacks ways to specify additional details such as object orientation and 3D pose. Instead, it is proposed to use per-pixel neural representation of an image as the conditioning information. Fine-tuning with this representation have no annotation cost, as they can be extracted from a corresponding image automatically using pretrained foundation models (e.g. DINO features, or Stable Diffusion features). At inference time, the neural representation can be edited to preserve desired information, such as object orientation and scene layout, while randomizing nuisance variables such as object texture and appearance. Such editing includes linear projections along semantically meaningful directions (obtained through, for example, Principal Component Analysis of the features), cut and pasting of conditioning information, and text-based editing.

In further aspects of the present invention, the diffusion model is utilized to generate training data images, which are utilized for training an image classifier.

In further aspects of the present invention, it is envisioned to use the classifier trained with one of the above methods by a method comprising the steps of:
receiving a sensor signal comprising data from a sensor,
determining an input signal which depends on said sensor signal, and
feeding said input signal into said classifier to obtain an output signal that characterizes a classification of said input signal.

According to an example embodiment of the present invention, the classifier or segmenter, e.g., a neural network, may be endowed with such structure that it is trainable to identify and distinguish, e.g., pedestrians and/or vehicles and/or road signs and/or traffic lights and/or road surfaces and/or human faces and/or medical anomalies in imaging sensor images. Alternatively, the classifier, e.g. a neural network, may be endowed with such structure that is trainable to identify spoken commands in audio sensor signals.

In a further aspect of the present invention, a computer-implemented method for using the classifier trained with the method according to any one of preceding aspects for providing an actuator control signal for controlling an actuator. Determining an actuator control signal depending on an output signal of the classificatory, which can be determined as described by the previous section. It is proposed that the actuator controls and at least partially autonomous robot and/or a manufacturing machine and/or an access control system.

In a further aspect of the present invention, a control system for operating the actuator is provided. According to an example embodiment of the present invention, the control system comprises the classifier adopted according to any of the preceding aspects or embodiments of the present invention and is configured to operate the actuator in accordance with an output of the classifier.

The present invention can be applied to various types of digital images, including video, radar, LiDAR, ultrasonic, motion, and thermal images. The invention can be used for classifying the sensor data, detecting the presence of objects in the sensor data or performing a semantic segmentation on the sensor data, e.g., regarding traffic signs, road surfaces, pedestrians, vehicles and/or object classes that could show in the semantic segmentation task, e.g., trees, sky, . . . .

The upstream core of the present invention involves active learning in a test bench setting. It can be utilized for various purposes such as selecting appropriate data points for training a machine learning system, testing/verifying/validating a machine learning system, or other specified use cases. The present invention interacts with a test bench, which may be replaced if deemed unsuitable, in the following manner.

In terms of active learning/testing and data curation, the present invention can be employed to actively select data that a technical system, transmits to a back-end computer. This selective process helps reduce data traffic. The information obtained from this data curation can then be utilized for training a machine learning system, testing/verifying/validating a machine learning system, or other specified use cases.

This interaction occurs as follows: the present invention serves as a method/data for training, acting as an upstream component in the machine learning tool chain. It does not directly enhance a machine learning system for the aforementioned applications. Instead, it serves as a method to train such a machine learning system, generate training data for this training, generate test data to ensure the safe operation of the trained machine learning system, or function as a generative model to produce the training or test data. Additionally, it can be used as a method to train the generative model itself.

Example embodiments of the present invention will be discussed with reference to the figures in more detail.

### BRIEF DESCRIPTION OF THE DRAWINGS

FIG. 1 shows a schematic flow diagram of Stable Diffusion.

FIG. 2 shows a schematic flow diagram of ControlNet.

FIG. 3 shows a schematic flow diagram of an extractor and the ControlNet.

FIG. 4 shows a schematic flow diagram of an extractor and the ControlNet for neural representation.

FIG. 5 shows a schematic flow diagram of Feature Extraction from Stable Diffusion.

FIG. 6 shows a schematic flow diagram of PCA.

FIG. 7 shows a schematic flow diagram of an extractor and the ControlNet with PCA.

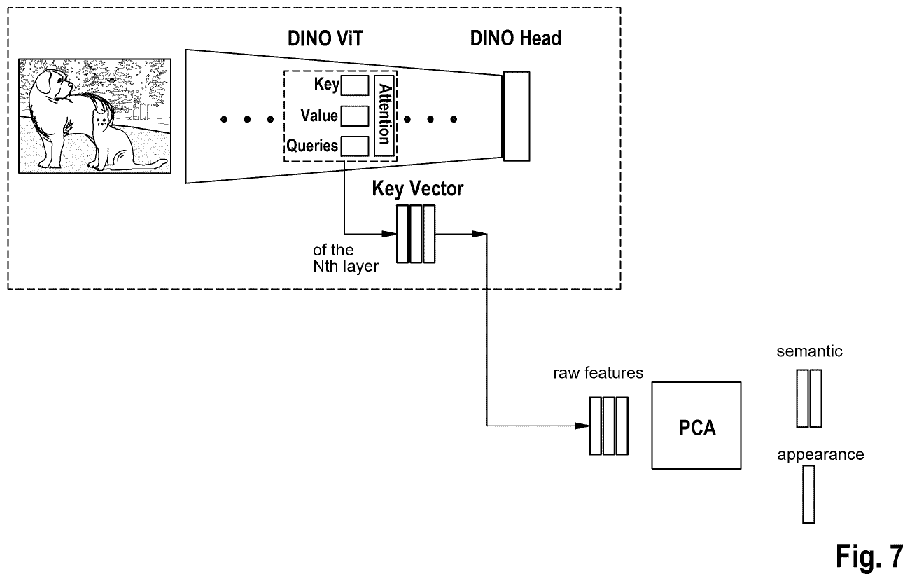

### DETAILED DESCRIPTION OF EXAMPLE EMBODIMENTS

Recent large-scale text-to-image diffusion models have demonstrated impressive performance. In particular, Stable Diffusion is the state-of-the-art open-source vision-language generative model trained over billions of text-image pairs. Stable Diffusion is a latent diffusion model, which is a special case of the diffusion model trained in a certain latent space instead of the original image space. More specifically, following VQ-GAN, Stable Diffusion firstly train an autoencoder, where the image is encoded into the latent space Z, and decoded back to reconstruct the given image. In the second stage, a diffusion model is trained in this latent space Z. In addition to the text input, recent works, e.g., ControlNet attempts to add other conditional inputs (e.g., label map, edges) to further increase controllability of the generation process. However, the inventors found existing conditioning inputs insufficient to describe the desired scene with enough specificity. In the following it is proposed to better design a conditional design for diffusion models fine-tuning, which better specifies the outcome of the generation without requiring manual annotations.

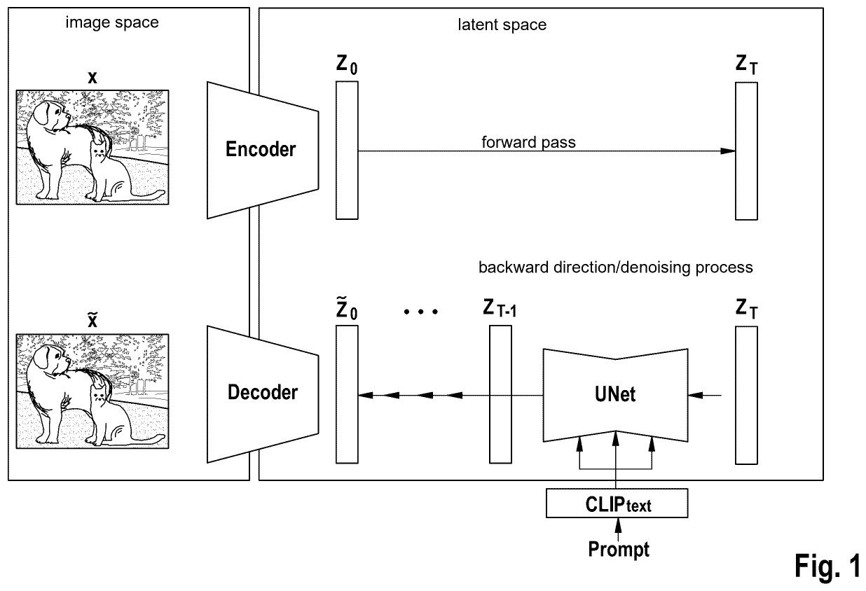

Instead of operating in the image space, Stable Diffusion (SD) operates in the latent space of an autoencoder, as illustrated in FIG. 1. Firstly, the encoder E maps the given image x into a spatial latent code z=E(x), then z is mapped back to the image space by the decoder D. The autoencoder is trained to reconstruct the given image, i.e., D(E(x))≈x.

In the second stage, a diffusion model is trained in this latent space Z. The diffusion model consists of a forward diffusion process and a backward denoising process. The forward pass is a Markov chain to gradually add Gaussian noise to the clean data. Formally, it can be written as: q(zₜ|zₜ₋₁)=N(zₜ, \sqrt{(1−βₜ)}zₜ₋₁, βₜI), where {βₜ} are fixed variance schedule. The noisy latent can be computed in a closed form, i.e., zₜ=\sqrt{(αₜ)}z₀+\sqrt{1−αₜ}ϵ,=ϵ˜N(0,I), where:

z₀= [symbol] ( [symbol] ) and αₜ:=Π [symbol] ₌₁^{t}(1−β [symbol] ).

The reverse denoising process can be parametrized by

p_{θ}(zₜ₋₁|zₜ):=N(zₜ₋₁;μ_{θ}(zₜ,t),σ_{θ}(zₜ,t)).

Essentially, μ_{θ}(zₜ, t) be expressed as a linear combination of zₜ and predicted noise ϵ_{θ}|(zₜ, t), which is modeled by a UNet. The parameters of the UNet can be learned by minimizing the L2 norm of the noise prediction at a sampled timestep t:

$${ℒ}_{noise} = {𝔼}_{z \sim ξ ( x ) , ϵ \sim N ( 0 , I ) , t} [ {‖ ϵ - {ϵ}_{θ} ( {z}_{t} , t ) ‖}^{2} ] \qquad eq . ( 1 )$$

For more mathematical derivation, we refer to DDPM.

At inference time, one can randomly sample z_{T} from the Gaussian distribution, then employ the trained denoising UNet sequentially, to obtain the denoised latent zₜ₋₁ given zₜ from to t=T to t=1. The final synthesized image can be obtained by feeding the clean latent z_0 through the decoder D.

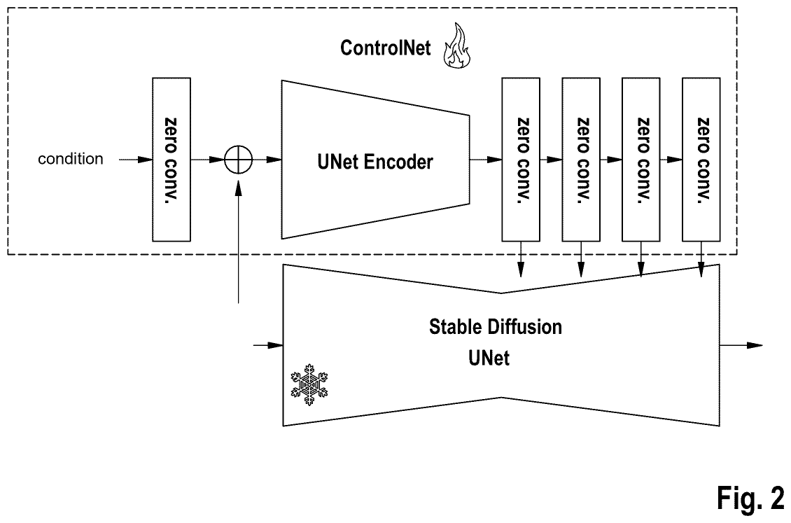

Recent work of ControlNet (arxiv.org/abs/2302.05543) propose to enhance the Stable Diffusion with additional conditions, e.g., label map. As illustrated in FIG. 2, ControlNet clones a trainable copy of the UNet encoder, and the original Stable Diffusion is frozen during the fine-tuning. The input condition is fed as the input of ControlNet and after the zero convolution layers and trainable encoder, the features are inserted back to the decoder of Stable Diffusion, where the zero convolution layers are essentially 1×1 convolution layers with both weight and bias initialized as zeros. The training objective is simply adopted from eq. (1) by inserting the condition y:

$${ℒ}_{noise} = {𝔼}_{z \sim ξ ( x ) , ϵ \sim N ( 0 , I ) , t} [ {‖ ϵ - {ϵ}_{θ} ( {z}_{t} , t , y ) ‖}^{2} ] \qquad eq . ( 2 )$$

It is proposed a system consisting of two parts: feature extraction, and conditional.

[symbol] generation. For feature extraction, prior works either use manual labor or error-prone neural networks to annotate high-level semantic information present in a human interpretable format (e.g. label or depth maps). The invention uses neural representation from foundation models to capture semantic information directly. The feature extraction first use pretrained foundation models (e.g. DINO, or Stable Diffusion) to obtain neural image representations from an image:

$${F}_{raw} = F M ( x ) \qquad eq . ( 3 )$$

where FM represents the frozen foundation model, x is the input image, and F_{raw} represents the extracted raw features.

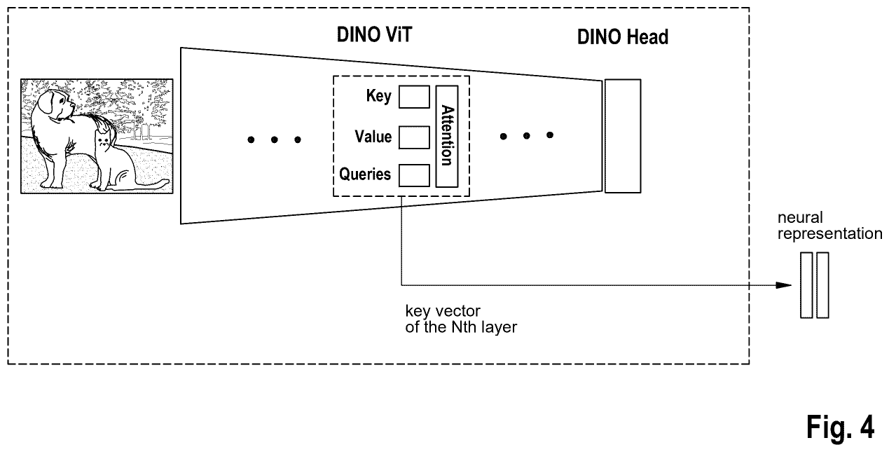

For example, prior work (Shir Amir et al in their paper “Deep ViT Features as Dense Visual Descriptors”) have demonstrated that the key values of the later layers (e.g., 9th, 11th) of the DINO ViT model (see FIG. 4) contain semantic information useful for part co-segmentation and correspondence matching.

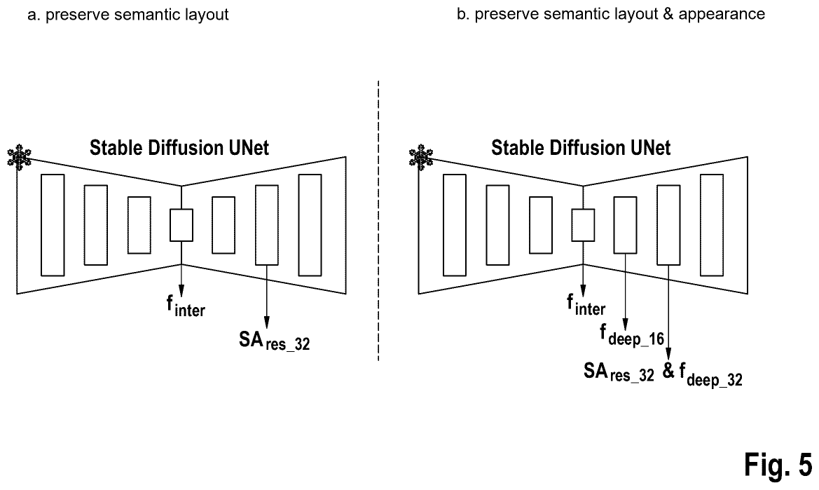

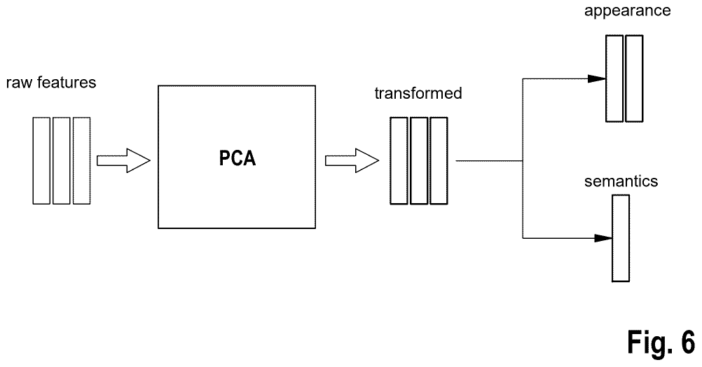

For Stable Diffusion, as shown in Plug-and-Play Diffusion Features for Text-Driven Image-to-Image Translation, spatial features within Stable Diffusion can well capture the semantic information, e.g., layout and object shape. And features at different layers can capture different granularity of details. More specifically, as illustrated in FIG. 5, spatial features extracted from intermediate decoder layers (f_inter) combined with self-attention maps at higher-resolution (SAres_32) can encoder the semantic layout information. While, when appearance information is desired to be preserved, deeper features (e.g., fdeep_16 and fdeep_32) can be added as well. It was shown that these types of neural image representation can be disentangled into high-level semantic information and low-level appearance details through the use of simple linear projections. For instance, the projections itself can be obtained by using Principal Component Analysis (PCA) and selecting the first n eigenvectors, as illustrated in FIG. 6. Due to these properties of neural representations, the desired high-level information content (e.g., object class and geometry) can be specified using a reference image, while discarding nuisance variations. Alternatively, the extracted features can be projected via learnable linear layers, or full features can be used to preserve details as much as possible. This projection step removes information of nuisance variations and captures only the relevant semantic information for the next step. The projected features F_trans is arranged into a pixel-aligned conditional image, where each pixel is the neural representation obtained from the projection.

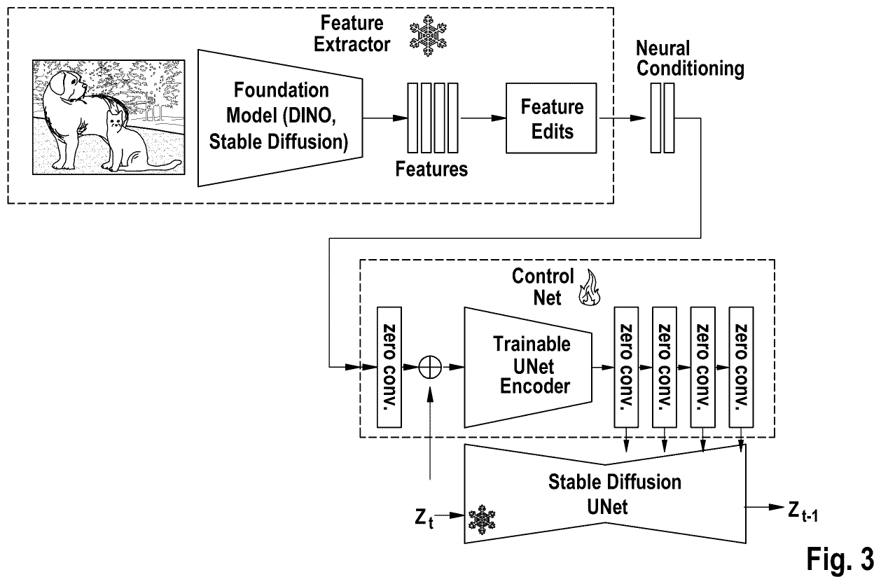

For conditional generation, we adapted prior work ControlNet (see FIG. 2) to take in the neural representation as conditioning information, as illustrated in FIG. 3. One can fine-tune ControlNet using pairings of extracted neural features and images on a target data domain. This trains the conditional generator to fill-in the nuisance information removed so that it can still generate realistic images. Formally, the training objective can be adapted from eq. (2) by inserting the transformed features Fₜᵣₐₙₛ:

$${ℒ}_{noise} = {𝔼}_{z \sim ξ ( x ) , ϵ \sim N ( 0 , I ) , t} [ {‖ ϵ - {ϵ}_{θ} ( {z}_{t} , t , {ℱ}_{trans} ) ‖}^{2} ] \qquad eq . ( 4 )$$

To summarize, the present invention leverages neural representation extracted from the frozen foundation models, which avoids the manual annotation and provides richer semantic information. This results in diverse high quality synthetic images which preserves the desired information content.

What is claimed is:

1. A computer-implemented method of generating synthetic images using a conditional diffusion model, the method comprising the following steps:
providing a neural conditioning for a ControlNet as input, wherein the neural conditioning has been determined by a foundation model for the to be generated synthetic image;
propagating the neural conditioning and a latent input representation for the diffusion model through the ControlNet, and providing outputs of the ControlNet as additional injections for the diffusion model; and
propagating the latent input representation through the diffusion model, wherein during the propagating of the latent input representation, the additional injections from the ControlNet are injected into corresponding layers of the diffusion model.

2. The method according to claim 1, wherein the neural conditioning is determined by propagating the to be generated synthetic image through the foundation model and selecting a plurality of intermediate results of the foundation model as the neural conditioning.

3. The method according to claim 2, wherein a Principal Component Analysis or a machine learning system is applied to the plurality of intermediate results to obtain the neural conditioning.

4. The method according to claim 1, wherein the neural conditioning is a per-pixel neural representation of a reference image.

5. The method according to claim 1, wherein the diffusion model includes a forward diffusion process and a backward denoising process, wherein for training the diffusion model, the following steps are performed:
obtaining a given image,
encoding the given image into a latent code using an encoder of an autoencoder,
generating a noisy latent code by adding Gaussian noise to clean latent code according to a fixed variance schedule, and
decoding the latent code back to the image space using a decoder of the autoencoder.

6. The method according to claim 1, wherein a synthetic image generated using the conditional diffusion model is used for training an image classifier.

7. The method according to claims 6, wherein the image classifier is used for controlling an at least partially autonomous robot and/or a manufacturing machine and/or an access control system.

8. A non-transitory machine-readable storage medium on which is stored a computer program generating synthetic images using a conditional diffusion model, the computer program, when executed by a processor, causing the processor to perform the following steps:
providing a neural conditioning for a ControlNet as input, wherein the neural conditioning has been determined by a foundation model for the to be generated synthetic image;
propagating the neural conditioning and a latent input representation for the diffusion model through the ControlNet, and providing outputs of the ControlNet as additional injections for the diffusion model; and
propagating the latent input representation through the diffusion model, wherein during the propagating of the latent input representation, the additional injections from the ControlNet are injected into corresponding layers of the diffusion model.

9. A system configured to generate synthetic images using a conditional diffusion model, the system configured to:
provide a neural conditioning for a ControlNet as input, wherein the neural conditioning has been determined by a foundation model for the to be generated synthetic image;
propagate the neural conditioning and a latent input representation for the diffusion model through the ControlNet, and providing outputs of the ControlNet as additional injections for the diffusion model; and
propagate the latent input representation through the diffusion model, wherein during the propagating of the latent input representation, the additional injections from the ControlNet are injected into corresponding layers of the diffusion model.
